(19) United States
(12) Patent Application Publication
(10) Pub. No.: US 2015/0112708 A1
(43) Pub. Date: Apr. 23, 2015

(54) METHODS AND SYSTEMS FOR MERGING AND ANALYZING HEALTHCARE DATA

(71) Applicant: The Charlotte-Mecklenburg Hospital Authority d/b/a Carolinas Healthcare System, Charlotte, NC (US)

(72) Inventors: B Todd Heniford, Charlotte, NC (US); Amy Lincourt, Charlotte, NC (US); Victor Tsirline, Lincolnshire, IL (US)

(21) Appl. No.: 14/521,922

(22) Filed: Oct. 23, 2014

Related U.S. Application Data
(60) Provisional application No. 61/894,599, filed on Oct. 23, 2013.

(51) Int. Cl. G06F 19/00

(52) U.S. Cl. CPC G06F 19/324
USPC 705/2

(57) ABSTRACT

Methods, apparatuses, and systems are provided according to example embodiments of the present invention to provide for extracting and standardizing data from dictated notes systems to provide a manageable format for search and analysis in clinical research and monitoring applications. Further embodiments provide for classifying data extracted from distinct dictated notes systems and identifying contextual relationships between the multiple datasets to generate a superset of data for research and clinical applications. In one embodiment, a method is provided that comprises extracting exam data from a dictation system; separating the extracted dataset into two or more files; standardizing variable names within the extracted dataset; importing the extracted dataset files into a database table; separating the imported data table into a primary table and a series of related tables; flattening the records within the related tables; linking the primary table records to the flattened related table records; and generating a final data table of exam records.

### CROSS-REFERENCE TO RELATED APPLICATIONS

The present application claims the benefit of U.S. Provisional Application No. 61/894,599, filed on Oct. 23, 2013, the contents of which are incorporated by reference herein in its entirety.

### TECHNOLOGICAL FIELD

Example embodiments of the present invention relate generally to providing data sets derived from multiple dictated note sources that may be compiled and used in clinical monitoring and research.

### BACKGROUND

Healthcare and other professionals often use systems for dictated notes to describe clinical procedures and observations, such an endoscopic procedures and pathology analysis. Several different dictated note systems may be used within the same organization, e.g. a healthcare system, by different groups creating distinct data sets although the data may be related to the same patients or procedures. Using data derived from such systems for research and statistical analysis is often limited as the large amount of data contained in these systems is often complex and not structured for such research purposes. Additionally, the relationships between data in the different systems may often not be easily apparent.

A number of deficiencies and problems associated with extracting and analyzing data from dictated note systems are identified herein. Through applied effort, ingenuity, and innovation, exemplary solutions to many of these identified problems are embodied by the present invention, which is described in detail below

### BRIEF SUMMARY

Methods and systems are provided according to example embodiments of the present invention to provide for extracting and standardizing data from dictated notes systems to provide a manageable format for search and analysis in clinical applications, research, and monitoring. Further embodiments provide for classifying data extracted from distinct dictated notes systems and identifying contextual relationships between the multiple datasets to generate a superset of data for research and clinical applications.

In one embodiment, a method is provided that at least includes extracting exam data from a dictation system; separating the extracted dataset into two or more files; standardizing variable names within the extracted dataset; importing the extracted dataset files into a database table; separating the imported data table into a primary table and a series of related tables; flattening the records within the related tables; linking the primary table records to the flattened related table records; and generating a final data table of exam records.

In some embodiments, the dictation system stores data related to endoscopy procedures. In some embodiments, the method may further comprise wherein extracting exam data from a dictation system comprises extracting data for a defined time period.

In some embodiments, the method may further comprise each of a plurality of exam records within the extracted exam data comprises data for one or more procedures and separating the extracted dataset into two or more files comprises generating a separate file for each of group of the one or more procedures.

In some embodiments, the method may further comprise wherein the primary table is an exam table comprising a plurality of exam records each with an associated exam identifier and each of the related tables comprises data of one category of information associated with the plurality of exam records. In some embodiments, the categories of information may comprise one or more of indications, impressions, findings, maneuvers, complications, recommendations, medications, or instruments.

In some embodiments, the method may further comprise developing recommendations based at least in part on analysis of the final data table of exam records. In some embodiments, the method may further comprise developing provider statistics based at least in part on analysis of the final data table of exam records.

In some embodiments, the method may further comprise wherein the exam data may be stratified by one or more of patient demographics, type of procedure, indications for procedure, findings, finding locations, or complications.

In another embodiment, a method is provided that at least includes receiving a formatted report from a dictation system; converting the formatted report and extracting into text; standardizing the extracted text; generating a separate record for each case entry within the text; importing the text into a database table; matching case records and report records within the text; parsing each report record into specimens; and generating a final dataset of cases and specimens.

In some embodiments, the dictation system stores data related to pathology reports.

In another embodiment, a method is provided that at least includes retrieving a first data set and a second data set; matching records of the first data set to records of the second data set using a first-level identifier; linking each of the matched records of the first data set and the second data set using the first data set record identifier and the second data set record identifier; determining relationships between the linked records; generating a final merged data set.

In some embodiments, the method may further comprise the first data set and the second data set comprise records for a defined time period. In some embodiments, the first data set comprises data related to endoscopy procedures and the second data set comprises data related to pathology reports.

In some embodiments, the method may further comprise developing recommendations based at least in part on analysis of the final merged data set. In some embodiments, the method may further comprise developing provider statistics based at least in part on analysis of the final merged data set. In some embodiments, the final merged dataset may be stratified by one or more categories associated with the records in the data set.

In another embodiment, an apparatus is provided comprising at least one processor and at least one memory including computer program instructions, the at least one memory and the computer program instructions being configured to, in cooperation with the at least one processor, cause the apparatus to at least extract exam data from a dictation system; separate the extracted dataset into two or more files; standardize variable names within the extracted dataset; import the extracted dataset files into a database table; separate the imported data table into a primary table and a series of related tables; flatten the records within the related tables; link the primary table records to the flattened related table records; and generate a final data table of exam records.

In some embodiments, the dictation system stores data related to endoscopy procedures. In some embodiments, extracting exam data from a dictation system comprises extracting data for a defined time period.

In some embodiments, each of a plurality of exam records within the extracted exam data comprises data for one or more procedures and separating the extracted dataset into two or more files comprises generating a separate file for each of group of the one or more procedures.

In some embodiments, the primary table is an exam table comprising a plurality of exam records each with an associated exam identifier and each of the related tables comprises data of one category of information associated with the plurality of exam records. In some embodiments, the categories of information may comprise one or more of indications, impressions, findings, maneuvers, complications, recommendations, medications, or instruments.

In some embodiments, the exam data may be stratified by one or more of patient demographics, type of procedure, indications for procedure, findings, finding locations, or complications.

In another embodiment, an apparatus is provided comprising at least one processor and at least one memory including computer program instructions, the at least one memory and the computer program instructions being configured to, in cooperation with the at least one processor, cause the apparatus to at least receive a formatted report from a dictation system; convert the formatted report and extracting into text; standardize the extracted text; generate a separate record for each case entry within the text; import the text into a database table; match case records and report records within the text; parse each report record into specimens; and generate a final dataset of cases and specimens

In some embodiments, the dictation system stores data related to pathology reports.

In another embodiment, an apparatus is provided comprising at least one processor and at least one memory including computer program instructions, the at least one memory and the computer program instructions being configured to, in cooperation with the at least one processor, cause the apparatus to at least retrieve a first data set and a second data set; match records of the first data set to records of the second data set using a first-level identifier; link each of the matched records of the first data set and the second data set using the first data set record identifier and the second data set record identifier; determine relationships between the linked records; and generate a final merged data set.

In some embodiments, the first data set comprises data related to endoscopy procedures and the second data set comprises data related to pathology reports. In some embodiments, the first data set and the second data set comprise records for a defined time period. In some embodiments, the final merged dataset may be stratified by one or more categories associated with the records in the data set.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a diagram of an exemplary system to provide healthcare data for clinical monitoring and research in accordance with an example embodiment of the present invention;

FIG. 2 is a flow chart illustrating operations for extracting data from a dictated notes system for research and analysis in accordance with an example embodiment of the present invention;

FIG. 3 is a flow chart illustrating operations for extracting data from a dictated notes system for research and analysis in accordance with an example embodiment of the present invention;

FIG. 4 is a flow chart illustrating operations merging datasets from distinct dictated notes systems and providing for research and analysis of the combined data in accordance with an example embodiment of the present invention;

FIG. 5 is a block diagram of an apparatus that may be specifically configured in accordance with example embodiments of the present invention;

FIGS. 6a-b illustrate an exemplary data set that may be generated in accordance with an example embodiment of the present invention; and

FIG. 7 illustrates an exemplary data set that may be generated in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Clinical research is highly dependent on the availability, accuracy, completeness, and suitability of data. Organizations, such as healthcare systems, often use dictation systems to describe and record clinical procedures and observations, such as endoscopic procedures and pathology analysis for example. These dictation systems may comprise extremely large data sets comprising data and observations for potentially hundreds of thousands of clinical procedures and/or analyses. Such data may provide valuable insights to clinical researchers however the data is often complex and the structure of the data is often not amenable to easy searching and analysis.

Further, such organizations may use multiple separate dictation systems based on the needs and desires of particular groups within the organization. For example, providers may use different dictation systems that are specifically configured for use in endoscopy procedures, pathology analysis, radiology, or the like. These separate dictation systems may create distinct sets of data; however the data housed in the separate systems may be related to a same patient and/or procedure. While such data may be able to provide valuable insights to clinical researchers; the separate dictation systems generally do not communicate with each other and are often not compatible and the data relationships may not be easily determined.

Embodiments of the present invention provide for extracting and standardizing data from dictated notes systems to provide a manageable format for search and analysis in clinical research and monitoring applications. Further embodiments provide for classifying data extracted from distinct dictated notes systems and identifying contextual relationships between the multiple datasets to generate a superset of data for research and clinical applications.

Some embodiments of the present invention may provide for extracting and compiling data derived from existing dictation systems, such as endoscopy dictation systems and pathology dictation systems, and converting the data to an optimized and standardized data structure allowing for more manageable search and analysis for clinical monitoring and research. For example, an endoscopy dictation system may provide data that describe clinical procedures and accompanying findings, locations, interventions and other related data and a pathology dictation system may provide data that describe tissue samples submitted for pathologic examination, gross and microscopic findings, and other related data.

Further embodiments may provide for classifying the data, identifying contextual relationships between the two datasets, and generating a superset of data, producing added meaning and value for research and clinical applications. Some embodiments may receive outputs from the dictation systems, standardize the output, import it into a database format, optimize the data structure, compile dictionaries, create standardized databases, and then link records between the databases to produce a final dataset.

Application of such systematic data mining methods may allow for rapid analysis of vast amounts of clinical data providing powerful research tools in a clinical practice. For example, embodiments may allow researchers to query and analyze significant amounts of raw data, analyzing hundreds of thousands of cases stratified by patient demographics, diagnosis, procedures, etc.

Embodiments of the present invention may allow for extracted and merged data to be used in a multitude of clinical research and monitoring applications, including research questions such as appropriateness of procedures for certain patient groups, expected pathologies for certain groups, research on comparative procedures/result comparisons, development of guidelines and/or recommendations, quality analysis, cost analysis, and reporting for doctors and fellows. In some embodiments, for example, the extracted and/or merged data may be used in research questions such as examining findings for all patients who had a particular procedure performed (e.g., a colonoscopy) to determine prevalence for certain diagnosis within various patient populations. In some embodiments, the extracted and/or merged data may be used in developing or revising guidelines, recommendations, or cost analysis, such as for Medicare.

In some embodiments, the extracted and/or merged data may be used in developing statistics and/or reporting for doctors or fellows in particular practices. For example, the data may be used to develop reporting and analysis for the number of procedures, type of procedures, types/categories of findings, complications, etc. on an individual, group, or system-wide basis. In some embodiments, for example, the extracted and/or merged data may be used in generating clinical case log reports required in residency and Fellowship programs.

For example, in one embodiment, the extracted and/or merged data could be used in research questions such as examining locations of polyps found during lower gastrointestinal endoscopy procedures for all patients to determine the incidence found in certain patient populations (e.g., younger patients, older patients, etc.). In such an example, embodiments could allow for the analysis of tens of thousands of cases stratified by patient demographics, procedure, diagnosis (locations, indications, etc.), complications, or the like. Such data and analysis could be used to draw conclusions as to what procedures are appropriate for a particular patient population and influence the development of guidelines or a standard of care for that patient population.

While embodiments of the invention are described in regard to endoscopy and pathology systems, potentially any type of dictated note system and any type of procedure (e.g., radiology) may be used in the various embodiments.

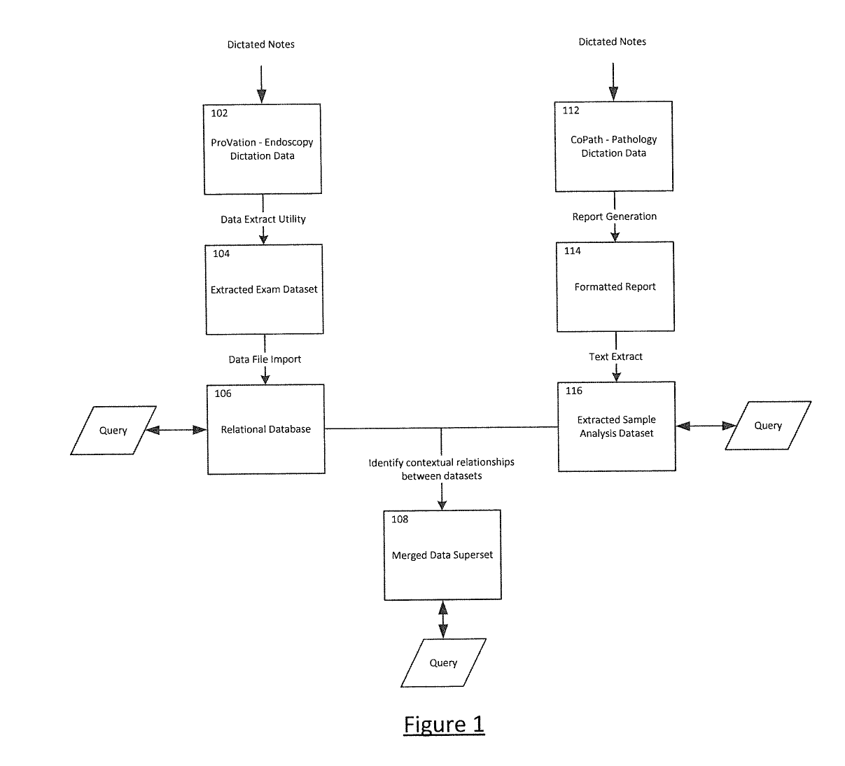

FIG. 1 illustrates exemplary systems to provide healthcare data for clinical monitoring and research in accordance with an example embodiment of the present invention. A first group within an organization, such as a healthcare system, may use a first dictated notes system, such as endoscopy dictation system 102. Various healthcare providers may record procedures and observations, such as during an endoscopy exam, which may then be transcribed into the dictated notes system, such as endoscopy dictation system 102. Records in the endoscopy dictation system 102 may include data related to patient medical record number, patient demographics, exam date, procedure name, provider names, provider roles, indications for the procedure, findings of the procedure including locations and corresponding maneuvers, complications, medications, impressions, recommendations, instruments used, and the like, for example.

In some embodiments, a text mining utility may be used to extract exam data from the endoscopy dictation system 102. The text mining utility may extract keywords and statements from the plurality of exam reports within the endoscopy dictation system. In some embodiments, the text mining utility may output a multi-dimensional variable length array of text values. In some embodiments, the text mining utility may output tab-separated spreadsheets, for example. The extracted text of the dataset, such as exams dataset 104, may be categorized into categories or columns such as procedure name, provider names, provider roles, indications, findings, locations, maneuvers, complications, medications, impressions, recommendations, instruments used, and the like, for example.

In some embodiments, each category descriptor may comprise multiple columns or fields of data per exam record, where there may be a variable number of columns for each descriptor. For example, each exam report may contain multiple procedures with multiples of each category variable within each procedure. The output may then be created with Procedure 1 with each of the associated category variables, such as provider_{—}1, role_{—}1, . . . provider_n, role_n, indication_{—}1, . . . indication_n, impression_{—}1, . . . impression_n, location_{—}1, finding_{—}1, fin1_maneuver_{—}1, . . . fin1_maneuver_n, location_n, finding_n, finn_maneuver_{—}1, . . . finn_maneuver_n, complication_{—}1, . . . complication_n, recommendation_{—}1, rec1_attribute_{—}1, . . . rec1_attribute_n, . . . recommendation_n, recn_attribute_{—}1, . . . recn_attribute_n, medication_{—}1, . . . medication_n, instrument_{—}1, instrument_type_{—}1, . . . instrument_n, instrument_type_n. etc., followed by Procedure 2 with each of the associated category variables, and so on.

To provide a more manageable format for searching and analyzing, the extracted dataset, such as exams dataset 104, may be converted into a systematic data structure. For example, in some embodiments, the extracted dataset may be modified and imported into a table in a relational database and then converted to a plurality of relational tables, such as relational database 106. Database 106 may then provide means for querying the exam data in a simpler and more manageable fashion for clinical monitoring and research.

A second group within the organization may use a second dictated notes system, such as pathology dictation system 112. Various healthcare providers may record analysis and observations of specimens, such as for pathology reports, which may then be transcribed into the dictated notes system, such as pathology dictation system 112. Records in the pathology dictation system 112 may include data related to patient medical record number, patient demographics, specimen date, ordering provider name, pathologist name, preoperative diagnosis, final diagnosis, and the like, for example.

In some embodiments, the pathology dictation system 112 may provide a formatted output of a plurality of pathology reports, such as formatted report 114. In some embodiments, the formatted output reports may be processed to extract the raw pathology report data. The raw pathology report data may then be processed to provide data for the specimens within the pathology reports for each case ordered. This pathology data may then be provided in a database, such as database 116, which may then provide means for querying the pathology data in a simpler and more manageable fashion for clinical monitoring and research.

In some embodiments, the dataset of the endoscopy dictation system 102 from database 106 and the dataset of the pathology dictation system 112 from dataset 116 may be merged to provide a superset of data for clinical research, such as merged data set 108.

For example, in some embodiments, the two datasets may be retrieved and a common identifier, such as a medical record number, from each dataset may be matched so that the distinct dataset records may be linked, such as by linking the endoscopy exam identifier to the pathology case identifier for the matched records.

In some embodiments, the matched records may then be analyzed to determine contextual relationships between the records from the two datasets. For example, in some embodiments, the records may be analyzed to match endoscopy findings with related pathology specimens. A final data superset, such as merged data superset 108, may then be generated by merging the two datasets based on the determined linking relationships. The system may then provide means for querying the merged data superset in a simpler and more manageable fashion for clinical monitoring and research.

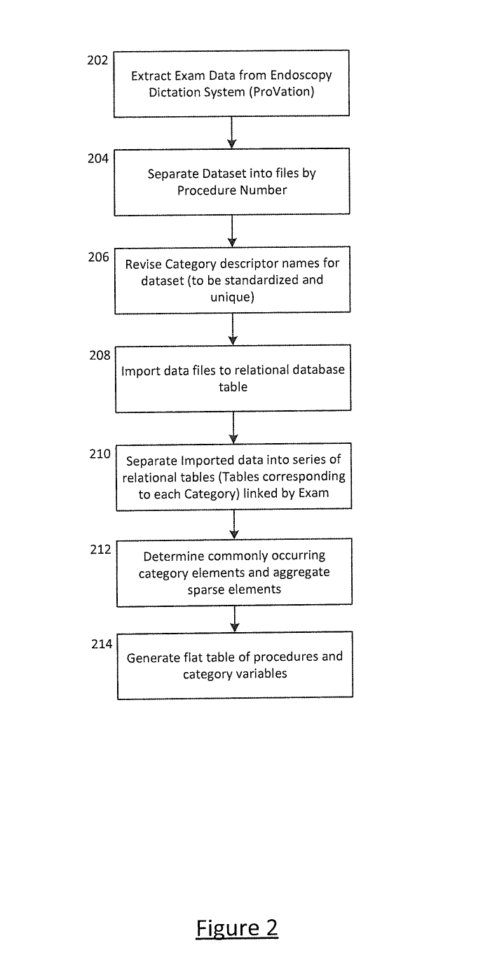

FIG. 2 is a flow chart illustrating operations for extracting data from a dictated notes system, such as for endoscopy exams, for research and analysis in accordance with an example embodiment of the present invention.

Dictation systems, such as endoscopy dictation system 102 described above in FIG. 1, often contain huge data sets comprising data and observations for potentially hundreds of thousands of exam procedures. Such data may provide valuable insights to clinical researchers however the data is often complex and the structure of the data is generally not amenable to easy searching and analysis. Some embodiments of the present invention provide for extracting data from existing dictation systems, such as an endoscopy dictation system, and converting the data to an optimized and standardized data structure allowing for more manageable search and analysis for clinical monitoring and research.

As shown in block 202, operations may begin by extracting exam data from a dictated notes system, such as exam data related to a plurality of endoscopy exams performed by providers of a healthcare system which may be housed in an endoscopy dictation system such as described in FIG. 1 above. In some embodiments, the exam data may be extracted such as by using a text mining utility as described above. The extracted exam data by be provided in an output format such as tab-separated spreadsheets or multi-dimensional variable length array of values.

At 204, the extracted exam dataset may be divided into a plurality of separate subsets or files based on the typical number of procedures per exam. For example, in one embodiment, each endoscopy exam may contain up to three procedures, so the exam dataset may be separated into three files, one for the first procedures, one for the second procedures, and one for the third procedures.

The extracted data set may comprise a set of categories of data for each of the procedures, such as procedure name, provider names, provider roles, indications, findings, locations, maneuvers, complications, medications, impressions, recommendations, instruments used, and the like, for example. Additionally each category of data may have one or more variables assigned for data within that category, such as indication1, indication2, etc. At block 206, the category variable names may be revised to ensure they are in a standard form compatible with a database format and unique within the exam procedure dataset.

At block 208, the modified extracted exam dataset files may be imported into a table in a relational database, where the table contains columns for all the variables that occur in the dataset. At block 210, the imported data table may then be separated into a series of relational tables for each of the categories of data, all being linked to a master table, such as an Exams table, in some embodiments. For example, in some embodiments, a series of update queries may be executed to create a series of tables such as Exams, Indications, Impressions, Findings, Maneuvers, Recommendations, Recommendation Attributes, Complications, Medications, and Instruments, or the like. The database may provide then means for querying the structured and standardized exam data for various clinical applications, research, and/or monitoring needs, such as pure research, formulating guidelines, quality analysis, cost analysis, provider analysis, and the like.

At blocks 212 and 214, further operations may be performed to provide additional means for statistical analysis by flattening the multi-variable data. At block 212, each of the variables is flattened by examining for commonly occurring data and combining sparse data into aggregate variables. For example, in some embodiments, a set of variables within each category is selected for pivoting (indicating if or how many times that particular variable appears in an exam) and the remaining variables are aggregated into an “Other” variable. This process may be completed for each of the category tables in the database, such as Indications, Impressions, Findings/Locations, Complications, Recommendations, etc. Once the flattened categories are generated, at block 214 a resulting flat dataset of the exam procedures is created. For example, in some embodiments, the flattening created a “Flat <descriptor>” table for each of the category tables which is then linked to the master Exam table to create a final output file.

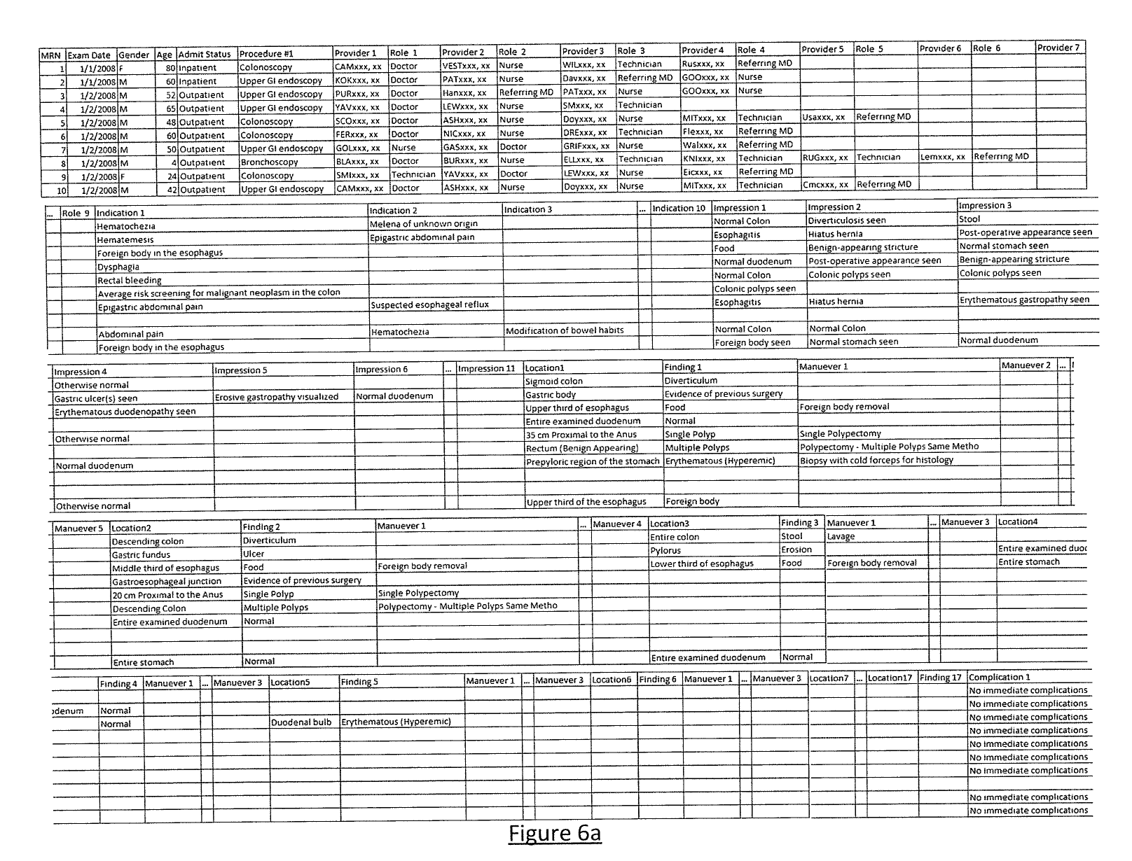

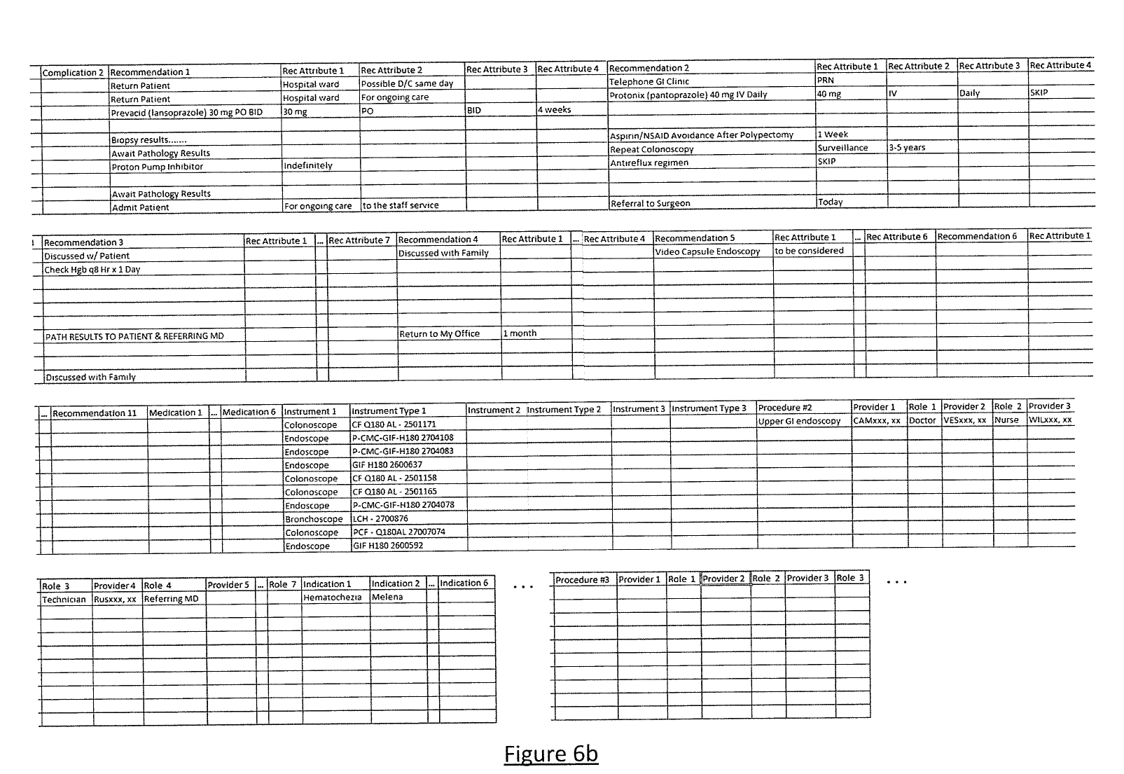

FIGS. 6a and 6b illustrate an exemplary data set, such as for endoscopy procedures, which may be generated in some embodiments through operations such as described in regard to FIG. 2 above.

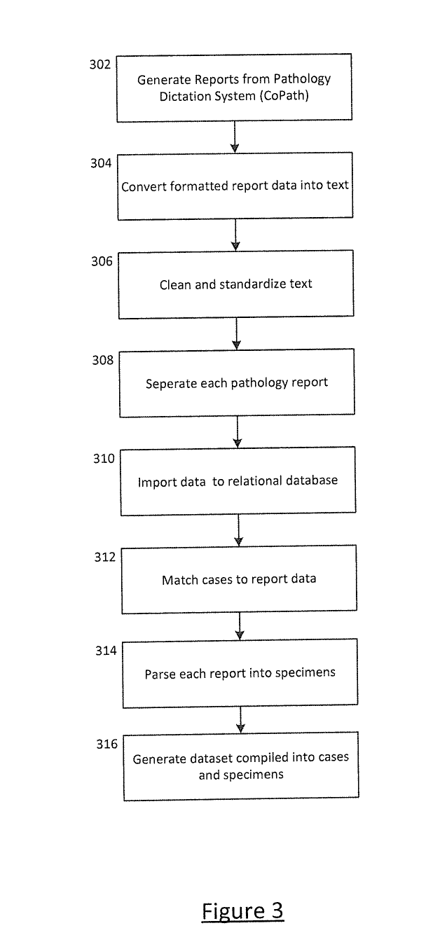

FIG. 3 provides a flow chart illustrating operations for extracting data from a dictated notes system, such as for pathology specimen analysis, for research and analysis in accordance with an example embodiment of the present invention.

Dictation systems, such as pathology dictation system 112 described above in FIG. 1, often contain huge data sets comprising data and observations for potentially hundreds of thousands of specimens. Such data may provide valuable insights to clinical researchers however the data may be complex, the structure may not amenable to easy searching and analysis, and the data may be distinct from other systems and not easily relatable. Embodiments of the present invention provide for extracting data from such existing dictation systems, such as a pathology dictation system, and converting the data to an optimized and standardized data structure allowing for more manageable search and analysis for clinical monitoring and research.

As shown in block 302, operations may begin by generating data in a defined report format from a dictated notes system, such as data related to pathology reports performed by providers of a healthcare system and which may be housed in a pathology dictation system such as described in FIG. 1 above.

At block 304, the generated report may be processed to convert the report into raw text data, such as by document format conversion, scanning, optical character recognition, or the like. At block 306, the converted text may be cleaned, filtered, and/or standardized. For example, in some embodiments, text such as report headers, report footers, control characters, unnecessary data fields, etc. may be removed or modified to provide a standardized text format.

At block 308, each pathology report within the report text may be identified and separated. For example, the text may be processed such that each pathology report is separated into an individual page or record.

At block 310, the converted data may then be imported into a database for further processing. At block 312, pathology cases and report data are matched to create a Cases table and a Reports tables linked by a Case ID, where the matching may be done using one or more variables within the data such as patient medical record number (MRN), patient name, patient date of birth, or the like. At block 314, the report data is analyzed to parse out the specimen data. At block 316, the final dataset of cases and specimens is generated. The database may then provide means for querying the structured and standardized case data for various clinical applications, research, and/or monitoring.

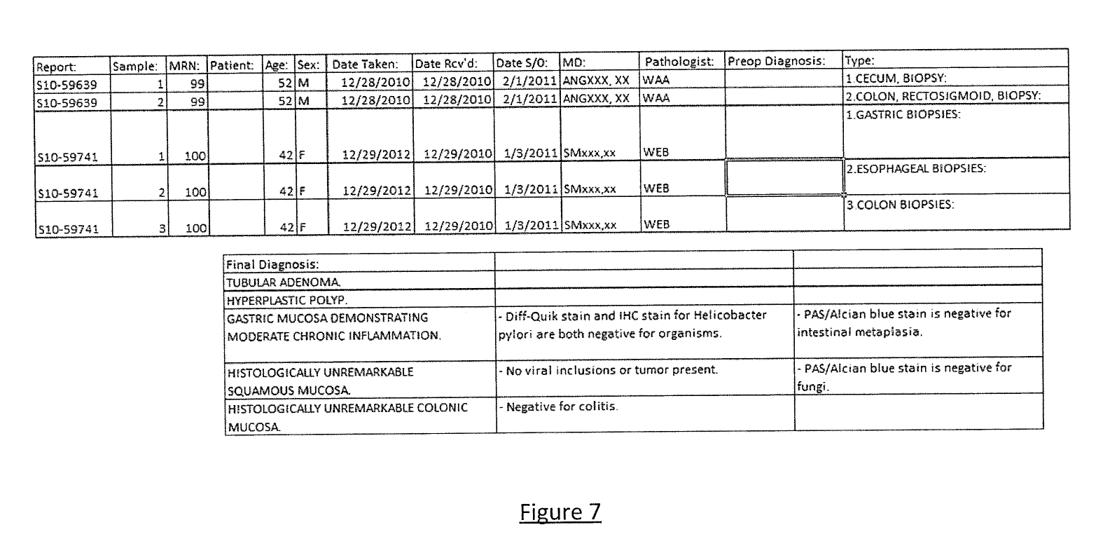

FIG. 7 provides an exemplary data set, such as for pathology data, which may be generated in some embodiments through operations such as described in regard to FIG. 3 above.

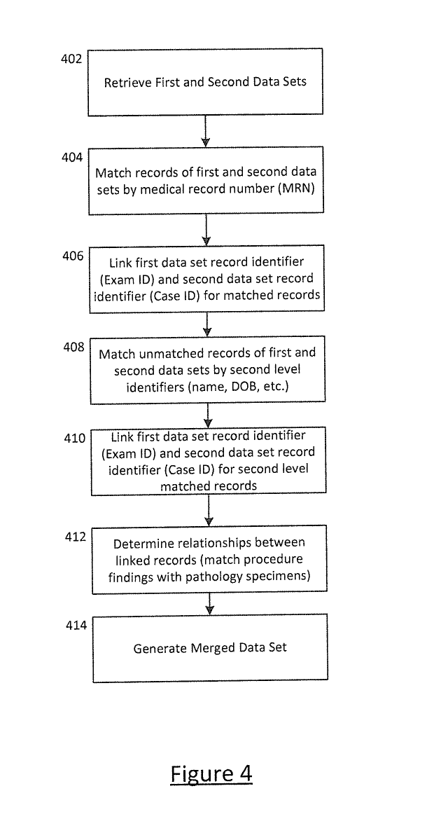

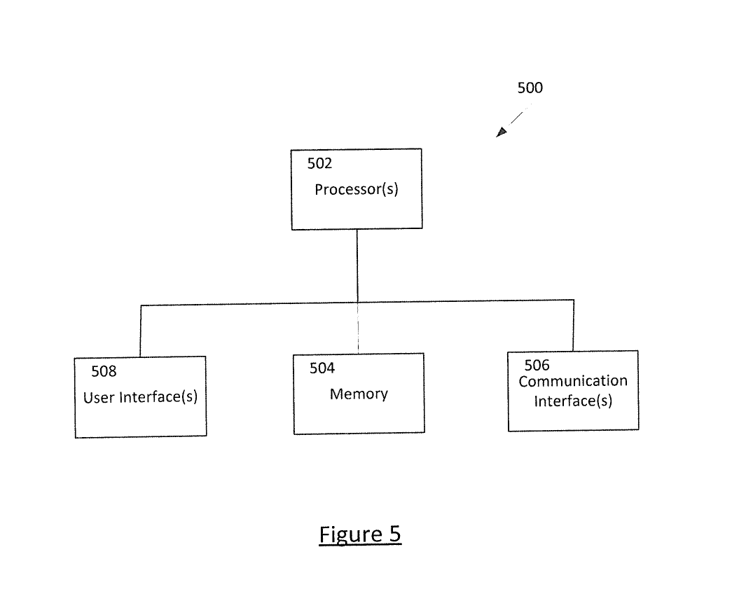

FIG. 4 provides a flow chart illustrating operations for merging datasets from separate and distinct dictated notes systems and generating a superset of merged data for searching and analysis in accordance with an example embodiment of the present invention.

Different groups within an organization, such as a healthcare system, may use different dictation systems that meet the needs of the particular group. These separate dictation systems create distinct sets of data; however data records in the various systems may be related to the same patient and/or procedure. Such data may be able to provide valuable insights to clinical researchers however the separate dictation systems generally do not communicate with each other and are often not compatible. Embodiments of the present invention provide for extracting data from distinct dictation systems, such as endoscopy dictation systems and pathology dictation systems described above, converting the data to optimized and standardized data structures, and linking or merging the datasets allowing for more manageable search and analysis for clinical research and monitoring.

As shown in block 402, operations may begin by retrieving a first data set and a second data extracted from separate dictated notes systems. For example, retrieving a dataset of endoscopy exams generated as described in regard to FIG. 2 above and retrieving a data set of pathology cases generated as described in regard to FIG. 3 above.

At block 404, the first dataset and the second dataset may be analyzed to determine records having matching first-level identifiers, such as medical record numbers associated with the endoscopy exams and pathology cases. At block 406, for each of the records of the first dataset and second dataset matched in block 404, the first dataset record identifier is linked to the second dataset record identifier. For example, in some embodiments, for each matched record in the endoscopy and pathology datasets, the endoscopy record Exam ID is linked to the pathology record Case ID.

At block 408, the first dataset and the second dataset may be analyzed to determine records that were not matched at block 404. These unmatched records may then be analyzed to determine records having matching second-level identifiers, such as patient names, name and date of birth, etc. At block 410, for each of the records of the first dataset and second dataset matched in block 408, the first dataset record identifier is linked to the second dataset record identifier. For example, in some embodiments, for each matched record in the endoscopy and pathology datasets, the endoscopy record Exam ID is linked to the pathology record Case ID.

At block 412, the linked records are analyzed to identify contextual relationship between the two datasets. For example, in some embodiments, the endoscopy exam findings and pathology specimens may be analyzed to identify matches. In some embodiments, successive iterations of analysis may be done to identify and match endoscopy exams with a single finding to pathology cases with a single specimen; to identify and match endoscopy findings and pathology specimens by the exact distance identified in both records; to identify and match endoscopy finding location identifiers with pathology location identifiers; to identify and match endoscopy findings and pathology specimens using approximate location term matching; or to identify and match endoscopy findings and pathology specimens using distance to anatomic location matching.

In some embodiments, where the identification and matching produces a number of duplicates, the duplicates may be reconciled in the following manner: when a single finding corresponds to multiple biopsies, let them duplicate; when multiple findings correspond to one biopsy, let them duplicate; where there are multiple findings and biopsies, match them sequentially.

At block 414, the merged data superset is generated. The data superset may then be queried producing added meaning and value for research and clinical applications.

For example, in one embodiment, the data superset may be developed to provide research insights such as the anatomic distribution of colonic polyps in various patient demographics by identifying the locations and types of findings across a large number of patient procedures as well as the pathology of the polyps found in the procedures.

FIG. 5 is a block diagram of an apparatus that may be specifically configured in accordance with an example embodiment of the present invention.

The system of an embodiment of the present invention may include an apparatus 500 as generally described below in conjunction with FIG. 5 for performing one or more of the operations set forth by FIGS. 1 through 4 and also described above.

It should also be noted that while FIG. 5 illustrates one example of a configuration of an apparatus 500 for merging and/or analyzing procedure and/or observation data, numerous other configurations may also be used to implement other embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

Referring now to FIG. 5, the apparatus 500 in accordance with one example embodiment may include or otherwise be in communication with one or more of a processor 502, a memory 504, a communication interface 506, and a user interface 508.

In some embodiments, the processor (and/or co-processors or any other processing circuitry assisting or otherwise associated with the processor) may be in communication with the memory device via a bus for passing information among components of the apparatus. The memory device may include, for example, a non-transitory memory, such as one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various operations in accordance with an example embodiment of the present invention. For example, the memory device could be configured to buffer input data for processing by the processor 502. Additionally or alternatively, the memory device could be configured to store instructions for execution by the processor.

The processor 502 may be embodied in a number of different ways. For example, the processor may be embodied as one or more of various hardware processing means such as a coprocessor, a microprocessor, a controller, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 502 may be configured to execute instructions stored in the memory device 504 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Meanwhile, the communication interface 506 may be any means such as a device or circuitry embodied in either hardware or a combination of hardware and software that is configured to receive and/or transmit data from/to a network and/or any other device or module in communication with the apparatus 500. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

The apparatus 500 may include a user interface 508 that may, in turn, be in communication with the processor 502 to provide output to the user and, in some embodiments, to receive an indication of a user input. For example, the user interface may include a display and, in some embodiments, may also include a keyboard, a mouse, a joystick, a touch screen, touch areas, soft keys, a microphone, a speaker, or other input/output mechanisms. The processor may comprise user interface circuitry configured to control at least some functions of one or more user interface elements such as a display and, in some embodiments, a speaker, microphone and/or the like. The processor and/or user interface circuitry comprising the processor may be configured to control one or more functions of one or more user interface elements through computer program instructions (e.g., software and/or firmware) stored on a memory accessible to the processor (e.g., memory 504, and/or the like).

As described above, FIGS. 2, 3, and 4 illustrate flowcharts of methods and systems according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 504 of an apparatus employing an embodiment of the present invention and executed by a processor 502 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as shown by the blocks with dashed outlines. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
extracting exam data from a dictation system;
separating the extracted dataset into two or more files;
standardizing variable names within the extracted dataset;
importing the extracted dataset files into a database table;
separating the imported data table into a primary table and a series of related tables;
flattening the records within the related tables;
linking the primary table records to the flattened related table records; and
generating a final data table of exam records.

2. The method of claim 1 wherein the dictation system stores data related to endoscopy procedures.

3. The method of claim 1 wherein extracting exam data from a dictation system comprises extracting data for a defined time period.

4. The method of claim 1 wherein each of a plurality of exam records within the extracted exam data comprises data for one or more procedures and wherein separating the extracted dataset into two or more files comprises generating a separate file for each of group of the one or more procedures.

5. The method of claim 1 wherein the primary table is an exam table comprising a plurality of exam records each with an associated exam identifier and each of the related tables comprises data of one category of information associated with the plurality of exam records.

6. The method of claim 5 wherein the categories of information may comprise one or more of indications, impressions, findings, maneuvers, complications, recommendations, medications, or instruments.

7. The method of claim 1 further comprising developing recommendations based at least in part on analysis of the final data table of exam records.

8. The method of claim 1 further comprising developing provider statistics based at least in part on analysis of the final data table of exam records.

9. The method of claim 1 wherein the exam data may be stratified by one or more of patient demographics, type of procedure, indications for procedure, findings, finding locations, or complications.

10. A method comprising:
receiving a formatted report from a dictation system;
converting the formatted report and extracting into text;
standardizing the extracted text;
generating a separate record for each case entry within the text;
importing the text into a database table;
matching case records and report records within the text;
parsing each report record into specimens; and
generating a final dataset of cases and specimens.

11. The method of claim 10 wherein the dictation system stores data related to pathology reports.

12. A method comprising:
retrieving a first data set and a second data set;
matching records of the first data set to records of the second data set using a first-level identifier;
linking each of the matched records of the first data set and the second data set using the first data set record identifier and the second data set record identifier;
determining relationships between the linked records; and
generating a final merged data set.

13. The method of claim 12 wherein the first data set comprises data related to endoscopy procedures and the second data set comprises data related to pathology reports.

14. The method of claim 12 further comprising developing recommendations based at least in part on analysis of the final merged data set.

15. The method of claim 12 further comprising developing provider statistics based at least in part on analysis of the final merged data set.

16. The method of claim 12 wherein the first data set and the second data set comprise records for a defined time period.

17. The method of claim 12 wherein the final merged dataset may be stratified by one or more categories associated with the records in the data set.

18. An apparatus, comprising:
at least one processor; and
at least one memory including computer program instructions, the at least one memory and the computer program instructions being configured to, in cooperation with the at least one processor, cause the apparatus to at least:
extract exam data from a dictation system;
separate the extracted dataset into two or more files;
standardize variable names within the extracted dataset;
import the extracted dataset files into a database table;
separate the imported data table into a primary table and a series of related tables;
flatten the records within the related tables;
link the primary table records to the flattened related table records; and
generate a final data table of exam records.

19. The apparatus of claim 18 wherein the dictation system stores data related to endoscopy procedures.

20. The apparatus of claim 18 wherein extracting exam data from a dictation system comprises extracting data for a defined time period.

21. The apparatus of claim 18 wherein each of a plurality of exam records within the extracted exam data comprises data for one or more procedures and wherein separating the extracted dataset into two or more files comprises generating a separate file for each of group of the one or more procedures.

22. The apparatus of claim 18 wherein the primary table is an exam table comprising a plurality of exam records each with an associated exam identifier and each of the related tables comprises data of one category of information associated with the plurality of exam records.

23. The apparatus of claim 22 wherein the categories of information may comprise one or more of indications, impressions, findings, maneuvers, complications, recommendations, medications, or instruments.

24. The apparatus of claim 18 wherein the exam data may be stratified by one or more of patient demographics, type of procedure, indications for procedure, findings, finding locations, or complications.

25. The apparatus of claim 18 further comprising the at least one memory and the computer program instructions being further configured to, in cooperation with the at least one processor, cause the apparatus to develop recommendations based at least in part on analysis of the final data table of exam records.

26. The apparatus of claim 18 further comprising the at least one memory and the computer program instructions being further configured to, in cooperation with the at least one processor, cause the apparatus to develop provider statistics based at least in part on analysis of the final data table of exam records.

27. An apparatus, comprising:
at least one processor; and
at least one memory including computer program instructions, the at least one memory and the computer program instructions being configured to, in cooperation with the at least one processor, cause the apparatus to at least:
receive a formatted report from a dictation system;
convert the formatted report and extracting into text;
standardize the extracted text;
generate a separate record for each case entry within the text;
import the text into a database table;
match case records and report records within the text;
parse each report record into specimens; and
generate a final dataset of cases and specimens.

28. The apparatus of claim 27 wherein the dictation system stores data related to pathology reports.

29. An apparatus, comprising:
at least one processor; and
at least one memory including computer program instructions, the at least one memory and the computer program instructions being configured to, in cooperation with the at least one processor, cause the apparatus to at least:
retrieve a first data set and a second data set;
match records of the first data set to records of the second data set using a first-level identifier;
link each of the matched records of the first data set and the second data set using the first data set record identifier and the second data set record identifier;
determine relationships between the linked records; and
generate a final merged data set.

30. The apparatus of claim 29 wherein the first data set comprises data related to endoscopy procedures and the second data set comprises data related to pathology reports.

31. The apparatus of claim 29 wherein the first data set and the second data set comprise records for a defined time period.

32. The apparatus of claim 29 wherein the final merged dataset may be stratified by one or more categories associated with the records in the data set.

33. The apparatus of claim 29 further comprising the at least one memory and the computer program instructions being further configured to, in cooperation with the at least one processor, cause the apparatus to developing recommendations based at least in part on analysis of the final merged data set.

34. The apparatus of claim 29 further comprising the at least one memory and the computer program instructions being further configured to, in cooperation with the at least one processor, cause the apparatus to developing provider statistics based at least in part on analysis of the final merged data set.
